(19) United States
(12) Patent Application Publication
(10) Pub. No.: US 2023/0102329 A1
(43) Pub. Date: Mar. 30, 2023

(54) MEMORY CONTROL METHOD

(71) Applicant: NEC Corporation, Minato-ku, Tokyo (JP)

(72) Inventor: Kazuhito ICHIMURA, Tokyo (JP)

(73) Assignee: NEC Corporation, Minato-ku, Tokyo (JP)

(21) Appl. No.: 17/802,681

(22) PCT Filed: Mar. 26, 2020
(86) PCT No.: PCT/JP2020/013812

§ 371 Date: Aug. 26, 2022

(51) Int. Cl. G06F 3/06

(52) U.S. Cl. CPC G06F 3/0653; G06F 3/0605; G06F 3/0679

(57) ABSTRACT

A memory control apparatus 100 according to the present invention includes execution means 121 configured to execute a program code to which a predetermined memory capacity is assigned and to measure an execution time in which the program code is executed, display means 122 configured to display execution status information including the execution time prior to newly executing the program code, and memory control means 123 configured to, when an additional memory capacity is requested prior to newly executing the program code, assign the additional memory capacity to the program code.

### TECHNICAL FIELD

The present invention relates to a memory control method, memory control apparatus, and program.

### BACKGROUND ART

A great amount of data is being analyzed in the field of artificial intelligence (AI), and services that provide a dedicated platform for performing such analysis are being actually used. Such a platform allows multiple users to share hardware resources such as a central processing unit (CPU) and a memory.

In AI analysis, a great amount of data is analyzed as described above and therefore a great amount of memory is often used. For this reason, much of the shared memory provided by the platform may be used by a user who analyzes a great amount of data. This leads to a problem that the performance of the entire platform is reduced when the upper limit of the hardware resource is reached.

On the other hand, users may be charged in accordance with the amount of used memory so that a particular user does not occupy the memory. In this case, users request appropriate additional memory in consideration of the time required by analysis to be performed by them or the amount to be charged. For example, Patent Document 1 predicts the job execution time of users and charges them in accordance with the predicted execution time. Accordingly, when a user wants to reduce the execution time, the user has to use more computational resources while being changed more.
Patent Document user terminals 1: Japanese Unexamined Patent Application Publication No. 2005-56201

### SUMMARY OF INVENTION

However, even if a user uses more of the memory, which is a hardware resource, while being charged more, the user may not obtain desired advantageous effects. The reason is that the above-mentioned job execution time is only the predicted one. This results in a difficulty in efficiently using the shared memory.

Accordingly, an object of the present invention is to provide a memory control method, memory control apparatus, and program capable of solving the above problem, that is, the problem that multiple users cannot efficiently use the shared memory.

### Solution to Problem

A memory control method according to one aspect of the present invention includes executing a program code to which a predetermined memory capacity is assigned and measuring an execution time in which the program code is executed, displaying execution status information including the execution time prior to newly executing the program code, and when an additional memory capacity is requested prior to newly executing the program code, assigning the additional memory capacity to the program code.

A memory control apparatus according to another aspect of the present invention includes execution means configured to execute a program code to which a predetermined memory capacity is assigned and to measure an execution time in which the program code is executed, display means configured to display execution status information including the execution time prior to newly executing the program code, and memory control means configured to, when an additional memory capacity is requested prior to newly executing the program code, assign the additional memory capacity to the program code.

A program according to yet another aspect of the present invention causes an information processing apparatus to function as execution means configured to execute a program code to which a predetermined memory capacity is assigned and to measure an execution time in which the program code is executed, display means configured to display execution status information including the execution time prior to newly executing the program code, and memory control means configured to, when an additional memory capacity is requested prior to newly executing the program code, assign the additional memory capacity to the program code.

The present invention thus configured allows multiple users to efficiently use the shared memory.

### BRIEF DESCRIPTION OF DRAWINGS

FIG. 1 is a block diagram showing a configuration of an information processing system according to a first example embodiment of the present invention;

FIG. 2 is a block diagram showing a configuration of a controller and a shared server disclosed in FIG. 1;

FIG. 3 is a diagram showing an example of data stored in the controller disclosed in FIG. 1;

FIG. 4 is a diagram showing the state of a process performed by the shared server in accordance with an operation of a user terminal disclosed in FIG. 1;

FIG. 5 is a diagram showing the state of assignment of hardware resources performed by the controller disclosed in FIG. 1;

FIG. 6 is a diagram showing the state of assignment of hardware resources performed by the controller disclosed in FIG. 1;

FIG. 7 is a flowchart showing an operation of the controller disclosed in FIG. 1;

FIG. 8 is a flowchart showing an operation of the controller disclosed in FIG. 1;

FIG. 9 is a block diagram showing a hardware configuration of a memory control apparatus according to a second example embodiment of the present invention;

FIG. 10 is a block diagram showing a configuration of the memory control apparatus according to the second example embodiment of the present invention; and

FIG. 11 is a flowchart showing an operation of the memory control apparatus according to the second example embodiment of the present invention.

### EXAMPLE EMBODIMENTS

### First Example Embodiment

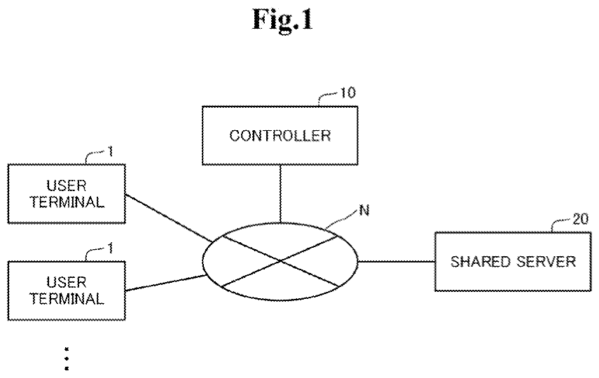

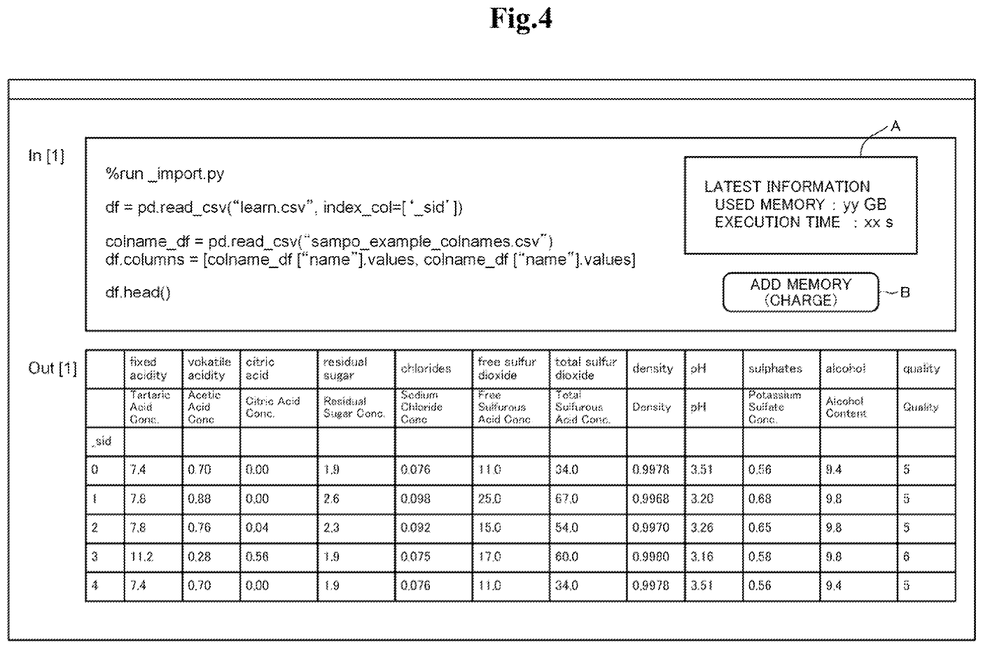

A first example embodiment of the present invention will be described with reference to FIGS. 1 to 8. FIGS. 1 to 3 are diagrams showing a configuration of an information processing system, and FIGS. 4 to 8 are diagrams showing a process operation of the information processing system.

[Configuration] The information processing system according to the present example embodiment aims to assign and provide hardware resources such as a CPU and a memory to multiple users so that the users can perform processes such as data analysis and model learning. In particular, the information processing system according to the present example embodiment is characterized in that it assigns and provides the capacity of a shared memory to multiple users, and is suitably used in analysis of a great amount of data in the field of artificial intelligence (AI).

As shown in FIG. 1, the information processing system includes user terminals 1 operated by users who perform data analysis, a shared server 20 that provides hardware resources for data analysis to the users, and a controller 10 that controls assignment of the hardware resources to the users and controls execution of processes such as data analysis using the hardware resources. The respective elements will be described below in detail.

The user terminals 1 are information processing terminals operated by the users and are connected to the controller 10 and shared server 20 through a network N. The user terminals 1 access the controller 10, request use of the shared server 20, and use the hardware resources of the shared server 20 assigned by the controller 10 in response to the requests to perform processes such as data analysis. For this reason, it is assumed that the users of the user terminals 1 have previously made contracts for use of the shared server 20 with a business that provides the shared server 20. For example, in the present example embodiment, it is assumed that 16 users have made such use contracts.

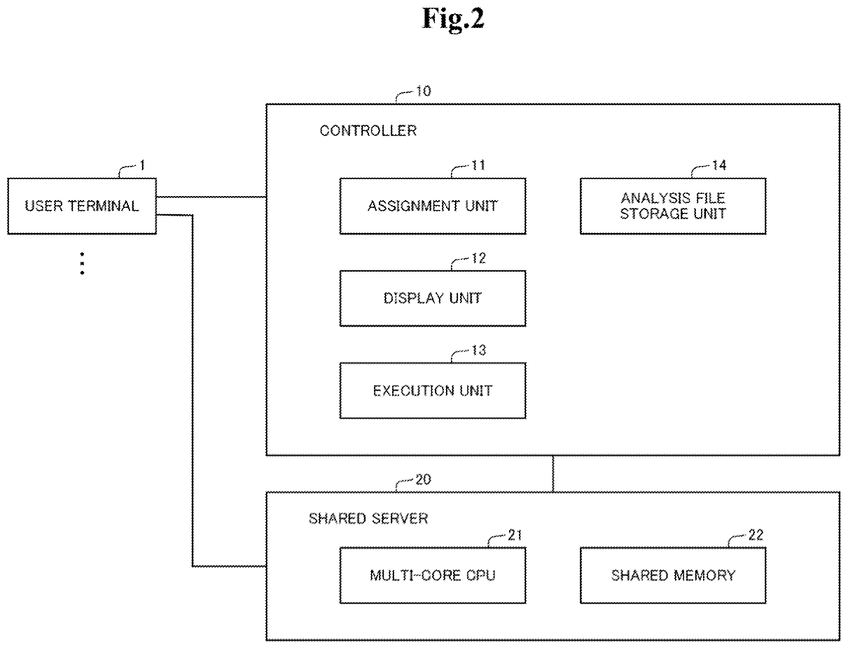

The shared server 20 consists of one or more information processing apparatuses each including an arithmetic logic unit and a storage unit. Specifically, as shown in FIG. 2, the shared server 20 according to the present example embodiment includes a multi-core CPU 21 and a shared memory 22 as hardware resources provided so as to be shared by multiple users. As an example, in the present example embodiment, the multi-core CPU 21 includes 16 cores, and the shared memory 22 has a capacity of 128 GB. As will be described later, for the shared memory 22, 64 GB, which is half the capacity of 128 GB, is set as a “guaranteed memory,” and the remaining half capacity, 64 GB, is set as an “added memory.” The shared server 20 assigns and provides the hardware resources to the users in accordance with an instruction from the controller 10.

The controller 10 (memory control apparatus) includes one or more information processing apparatuses each including an arithmetic logic unit and a storage unit. As shown in FIG. 2, the controller 10 includes an assignment unit 11, a display unit 12, and an execution unit 13. The functions of the assignment unit 11, display unit 12, and execution unit 13 are implemented when the arithmetic logic unit executes a program for implementing those functions stored in the storage unit. The controller 10 also includes an analysis file storage unit 14. The analysis file storage unit 14 consists of a storage device. The respective elements will be described below in detail.

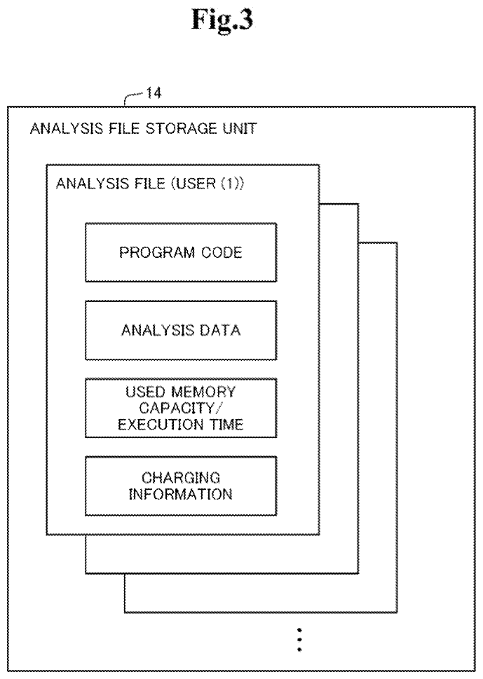

The analysis file storage unit 14 is storing analysis files including data used by the contract users to perform analysis. Specifically, as shown in FIG. 3, the stored analysis files correspond to the users, and each analysis file includes a “program code” for performing analysis and “analysis data” processed in the execution of the program code. In particular, the “program code” according to the present example embodiment is the code of a program related to so-called AI technology such as data analysis or model learning. Note that the program code may be a program code used in any technology. As an example, the program code is a code as shown in a symbol In[1] field of FIG. 4 and performs a process of loading analysis data from an analysis file and displaying the loaded data as shown in a symbol Out[1] field of FIG. 4. For example, the “analysis data” consists of 11 types of component data of wines and data representing the quality of the wines (grades obtained by evaluating the taste), and each grade is the median value of evaluations made by three or more authorized wine assessors and is 0 to 10. Each analysis file also includes “used memory capacity/execution time” and “charging information” (to be discussed later).

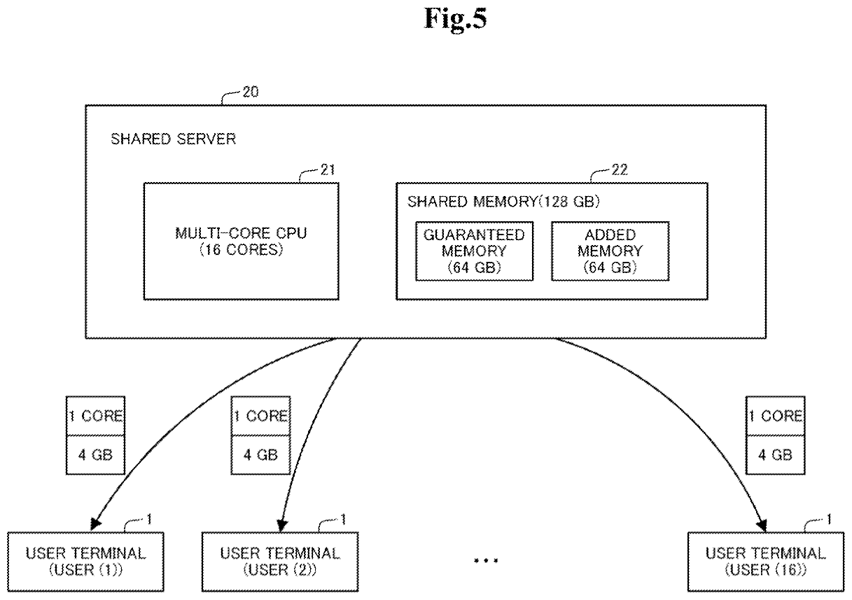

The assignment unit 11 (memory control means), upon access from the user terminals 1, assigns the hardware resources to the user terminals 1, that is, the users. Specifically, the assignment unit 11 first uniformly assigns the hardware resources to the users. For example, as shown in FIG. 5, the assignment unit 11 assigns each core of the multi-core CPU 21 consisting of 16 cores and each 4 GB of the “guaranteed memory” (first memory) having a capacity of 64 GB to each of the 16 users. That is, as will be described later, the assignment unit 11 assigns the predetermined memory capacity to the program codes included in the analysis files of the users.

Thus, even if the 16 users simultaneously access the shared server 20 and request the hardware resources, the hardware resources, in particular, 4 GB of memory capacity are uniformly guaranteed and assigned to all the users. Thus, the users are able to reliably perform analysis using the assigned hardware resources. Note that at this time, the assignment unit 11 does not assign the “added memory” (second memory) having a capacity of 64 GB but rather reserves it as a surplus memory capacity.

As will be described later, when any user requests additional memory, the assignment unit 11 additionally assigns a predetermined memory capacity of the “added memory” to the user. Or, as will be described later, the assignment unit 11 additionally assigns a predetermined memory capacity of the “guaranteed memory” to the user in accordance with the hardware resource use status of the other users.

The display unit 12 (display means), upon a request from any user terminal 1, reads an analysis file corresponding to the user of the user terminal 1 and outputs a “program code” included in the analysis file to the user terminal 1 to display the program code on the display unit of the user terminal 1. For example, the display unit 12 displays a display screen as shown in FIG. 4 on the display unit of the user terminal 1 and displays the program code as shown in the symbol In[1] field of FIG. 4. Also, as will be described later, when the program code is executed, the display unit 12 outputs the execution results to the user terminal 1 to display the execution results on the display unit of the user terminal 1. For example, data as shown in the symbol Out[1] field of FIG. 4 is shown as the execution results.

When outputting the program code to the user terminal 1 to display the program code on the display unit of the user terminal 1, the display unit 12 also outputs information on “used memory/execution time” included in the analysis file to the user terminal 1 along with the program code to display the information on the display unit of the user terminal 1 as shown by a symbol A of FIG. 4. Further, along with the information on “used memory/execution time,” the display unit 12 outputs an “add memory button” B for requesting an additional memory capacity to the user terminal 1 to display the button on the display unit of the user terminal 1 as shown in FIG. 4. Details of this process will be described later.

When executing the program code in accordance with the request from the user terminal 1, the execution unit 13 (execution means) performs control so that the program code is executed using the hardware resources (1-core CPU and 4-GB memory) assigned to the user terminal 1, that is, the user. At this time, the execution unit 13 measures the “used memory capacity” representing a memory capacity used in the execution of the program code, measures the “execution time,” in which the program code is executed, and stores the used memory capacity and the execution time in the corresponding analysis file. Thus, when the program code is executed even once, the used memory capacity and the execution time are stored in the analysis file including the program code. Note that, as will be described later, when an additional memory capacity is assigned to the program code, the execution unit 13 performs control so that the program code is executed using the additional memory capacity.

The execution unit 13 may overwrite and store the used memory capacity and the execution time in the analysis file with those measured in the latest execution of the program code, or may store, in the analysis file, all the used memory capacities and execution times measured in a past predetermined period, or may measure and store only one of the used memory capacity and the execution time.

Next, the display unit 12 will be further described. Here, it is assumed that the program code has been executed at least once and the used memory capacity and the execution time are stored in the analysis file as described above. When the user newly executes the previously executed program code, the display unit 12 again reads the program code included in the analysis file corresponding to the user and outputs the program code to the user terminal 1 to display the program code on the display unit of the user terminal 1 as shown in the symbol In[1] field of FIG. 4. Since the used memory capacity and the execution time are stored in the analysis file including the displayed program code, the display unit 12 also outputs the used memory capacity and the execution time to the user terminal 1 to display such information on the display unit of the user terminal 1 as shown by the symbol A of FIG. 4. Further, along with the information on the used memory capacity and the execution time, the display unit 12 outputs the add memory button B for requesting an additional memory capacity to the user terminal 1 to display the button on the display unit of the user terminal 1 as shown by the symbol B of FIG. 4.

The display unit 12 may output only the used memory capacity and the execution time measured in the latest execution of the program code to the user terminal 1 to display such information on the user terminal 1. Or, the display unit 12 may output the used memory capacities and execution times measured multiple times in the past to the user terminal 1 to display such information on the user terminal 1, or may output the compilation results such as the average values or maximum values of such information to the user terminal 1 to display the compilation results on the user terminal 1, or may output one of the used memory capacity and the execution time to the user terminal 1 to display such information on the user terminal 1. The display unit 12 need not necessarily output the used memory capacity and the execution time to the user terminal 1 to display such information on the same screen as that of the program code but rather may output the used memory capacity and the execution time to the user terminal 1 to display such information on a screen different from that of the program code of the user terminal 1.

As described above, before the program code is executed, the display unit 12 outputs the used memory capacity and the execution time measured in the past execution of the program code to the user terminal 1 to display such information on the user terminal 1. This allows the user to recognize the past execution status of the program code. The user then determines whether to request assignment of an additional memory capacity in accordance with the past execution status. If the user determines that additional memory should be requested, the user pushes the add memory button B displayed on the user terminal 1. The display unit 12 detects that the add memory button B has been pushed and sends a notification to that effect to the assignment unit 11.

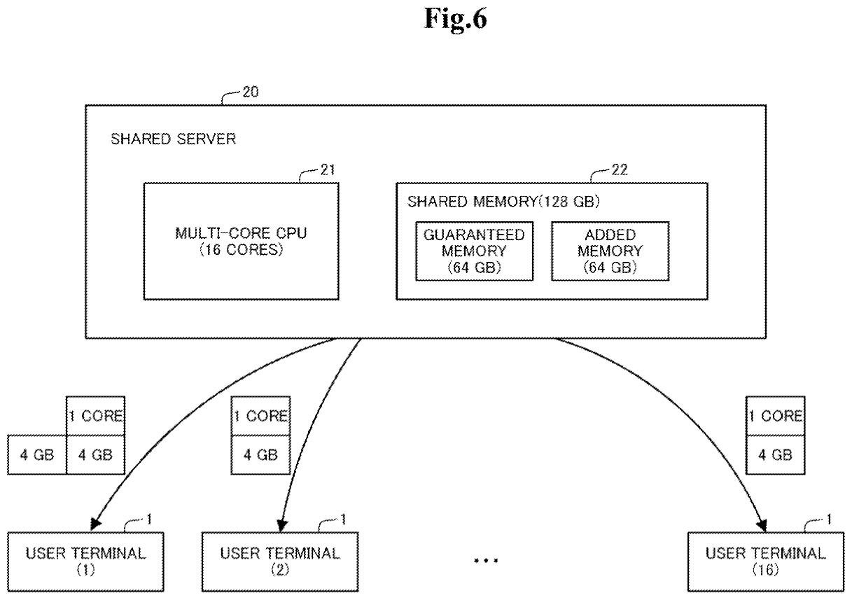

Next, the assignment unit 11 will be further described. Here, a case will be described in which the add memory button B is pushed by the user and the notification to that effect is received as described above. Upon receipt of the notification that the add memory button B has been pushed, the assignment unit 11 recognizes that assignment of an additional memory capacity has been requested by the user and assigns the additional memory capacity to the program code that the user has yet to execute. At this time, for example, the assignment unit 11 additionally assigns 4 GB of capacity of the “added memory” having a capacity of 64 GB to the user who has made this request. As shown in FIG. 6, this means that the assignment unit 11 has assigned, to the user (1) who has requested additional memory, the 4-GB capacity of the “guaranteed memory” as well as the additional 4-GB capacity of the “added memory,” that is, has assigned a total of 8 GB memory capacity to this user.

The assignment unit 11 may limit, to once, the frequency with which one user can request assignment of an additional memory capacity, or may limit, to 4 GB, the additional memory capacity whose assignment one user can request. In such a case, even if all the 16 users request assignment of an additional memory capacity, the assignment unit 11 is able to uniformly additionally assign each 4 GB of the “added memory” of 64 GB to each user. Conversely, the assignment unit 11 may not limit the above frequency or additional memory capacity. In this case, the assignment unit 11 may additionally assign a predetermined capacity of the “added memory” to a user who has requested assignment of an additional memory capacity multiple times, as long as the “added memory” has space. Or, the assignment unit 11 may additionally assign a predetermined capacity of the “guaranteed memory” to a user who has requested assignment of additional memory, in accordance with the program code execution status of the other users. Specifically, although the “guaranteed memory” is a memory prepared to assign a minimum memory capacity (e.g., 4 GB) to each user, the minimum capacity may not have been assigned to the program code of a user other than a user who has requested assignment of additional memory since the other user has not used the guaranteed memory to execute the program code thereof. In this case, the assignment unit 11 may additionally assign the minimum capacity for the other user to the request user.

To assign the additional memory capacity, it is necessary to additionally charge the user. For this reason, when the user presses the add memory button B before executing the program code and the assignment unit 11 assigns the additional memory capacity in response as described above, the assignment unit 11 performs a charging process (charging means). Specifically, the assignment unit 11 stores charging information representing an amount charged due to the assignment of the additional memory capacity, in the analysis file corresponding to the program code to which the additional memory capacity has been assigned. At this time, the assignment unit 11 may use a predetermined amount as a charged amount. Or the assignment unit 11 may calculate a charged amount in accordance with the memory addition status. For example, the assignment unit 11 may calculate a charged amount so that the charged amount is increased as the additional memory capacity is greater, or may calculate a charged amount so that the charged amount is increased as the space of the shared memory 22 is smaller. For another example, the assignment unit 11 may calculate a different charged amount in accordance with the frequency of memory addition, or may calculate a different charged amount in accordance with the time zone in which additional memory has been requested. Note that the above-mentioned charged amount calculation methods used by the assignment unit 11 are illustrative only and any method may be used to calculate a charged amount.

### [Operation]

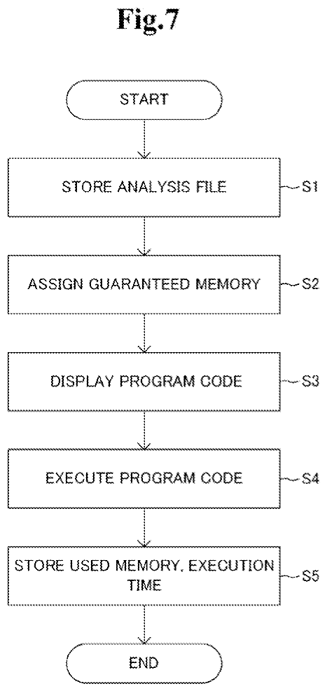

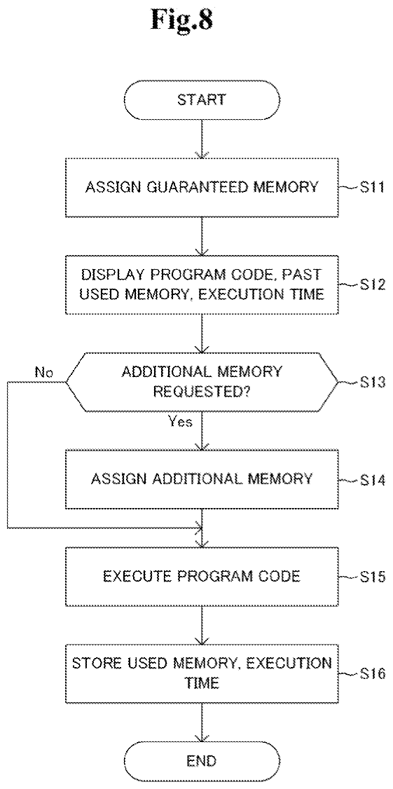

Next, an operation of the information processing system, in particular, an operation of the controller 10 will be described mainly with reference to the flowcharts of FIGS. 7 and 8. First, referring to FIG. 7, an operation when a user performs a program code for the first time will be described.

The controller 10 receives an analysis file from each user terminal 1 and stores it in association with the user (step S1). For example, as shown in FIGS. 3 and 4, each analysis file includes a program code and analysis data.

Then, in response to access from each user terminal 1, the assignment unit 10 assigns the hardware resources to the user terminal 1, that is, the user. For example, as shown in FIG. 5, the controller 10 assigns each core of the multi-core CPU 21 consisting of 16 cores and each 4 GB of the “guaranteed memory” having a capacity of 64 GB to each of the 16 users (step S2). As seen above, the controller 10 uniformly guarantees and assigns the hardware resources, in particular, the 4-GB memory capacity to all the users. At this time, the controller 10 does not assign the “added memory” having a capacity of 64 GB but rather reserves it as a surplus memory capacity.

Then, upon a request from a user terminal 1, the controller 10 reads an analysis file corresponding to the user of the user terminal 1. The controller 10 outputs a “program code” included in the analysis file to the user terminal 1 to display the program code on the display unit of the user terminal 1 (step S3). For example, the controller 10 outputs a display screen as shown in FIG. 4 to the user terminal 1 to display it on the display unit of the user terminal 1. At this time, the program code is displayed as shown in the symbol In[1] field of FIG. 4. Note that the controller 10 does not display information represented by the symbols A and B of FIG. 4. This is because this program code has not been executed and the used memory capacity and the execution time measured in the past execution thereof are not stored in the analysis file.

Then, upon the request from the user terminal 1, the controller 10 performs control so that the program code displayed on the user terminal 1 is executed. Specifically, the controller 10 performs control so that the program code is executed using the hardware resources (1-core CPU and 4 GB memory) assigned to the user terminal 1, that is, the user (step S4). At this time, the controller 10 measures the used memory capacity representing a memory capacity used in the execution of the program code, measures the execution time in which the program code is executed, and stores the used memory capacity and the execution time in the corresponding analysis file (step S5).

Next, referring to FIG. 8, an operation when a user executes a program code as described above, then performs modification or the like of the program code, and again executes the program code will be described. As described above, upon access from each user terminal 1, the controller 10 assigns the hardware resources to the user terminal 1, that is, the user. For example, as shown in FIG. 5, the controller 10 assigns each core of the multi-core CPU 16 consisting of 16 cores and each 4 GB of the guaranteed memory having a capacity of 64 GB to the 16 users (step S11).

Then, upon a request from a user terminal 1, the controller 10 reads an analysis file corresponding to the user of the user terminal 1. The controller 10 then outputs a “program code” included in the analysis file to the user terminal 1 to display the program code on the display unit of the user terminal 1 (step S12). For example, the controller 10 displays the program code as shown in the symbol In[1] field of FIG. 4. Since the used memory capacity and the execution time are also stored in the analysis file including the displayed program code, the controller 10 also outputs the used memory capacity and the execution time to the user terminal 1 to display such information on the display unit of the user terminal 1 as shown by the symbol A in the symbol In[1] of FIG. 4 (step S12). Further, along with the information on the used memory capacity and the execution time, the controller 10 outputs the add memory button B for requesting an additional memory capacity to the user terminal 1 to display the button on the display unit of the user terminal 1 as shown by the symbol B of FIG. 4.

Then, prior to executing the program code, the user recognizes the used memory capacity and the execution time measured in the past execution of the program code and determines whether to request assignment of an additional memory capacity, in accordance with this status. If the user determines that assignment of an additional memory capacity should be requested, the user pushes the add memory button B displayed on the user terminal 1. The controller 10 detects that the add memory button B has been pushed and assignment of an additional memory capacity has been requested by the user (YES in step S13).

Upon the request of assignment of the additional memory capacity, the controller 10 assigns the additional memory capacity to the program code that the user has yet to execute (step S14). At this time, the controller 10 additionally assigns a 4-GB capacity of the “added memory” having a capacity of 64 GB to the program code of the user. As shown in FIG. 6, this means that the controller 10 has assigned, to the user (1) who has requested additional memory, the 4-GB capacity of the “guaranteed memory” as well as the additional 4-GB capacity of the “added memory,” that is, has assigned a total of 8 GB memory capacity to this user.

When executing the program code in accordance with the request from the user terminal 1, the controller 10 performs control so that the program code is executed using the hardware resources (1-core CPU and 8-GB memory) assigned to the user terminal 1, that is, the user (step S15). For example, as the results of the execution of the program code as shown in the In[1] field of FIG. 4, the controller 10 outputs data as shown in the symbol Out[1] field of FIG. 4 to the user terminal 1 to display the data on the user terminal 1. The controller 10 also measures the used memory capacity representing a memory capacity used in the execution of the program code, measures the execution time in which the program code is executed, and stores the used memory capacity and the execution time in the corresponding analysis file (step S16). Note that when the controller 10 assigns the additional memory capacity as described above, it stores charging information representing a charged amount corresponding to the added memory capacity in the analysis file including the program code.

As described above, in the present example embodiment, before the user executes the program code, the used memory capacity and the execution time measured in the past execution of the program code are outputted to the user terminal 1 to display such information on the user terminal 1. This allows the user to recognize the past execution status of the program code and to determine whether to request assignment of an additional memory capacity in accordance with the past execution status. If the user determines that additional memory should be requested, the user requests assignment of an additional memory capacity. Thus, additional memory is assigned to the user who has requested additional memory on the basis of the past execution status of the program code. This allows the multiple users to efficiently use the shared memory.

In the present example embodiment, the memory capacity assigned to the multiple users is guaranteed. This prevents a particular user from occupying the memory and provides a fair use environment, resulting in an improvement in the quality of services provided by the platform.

### Second Example Embodiment

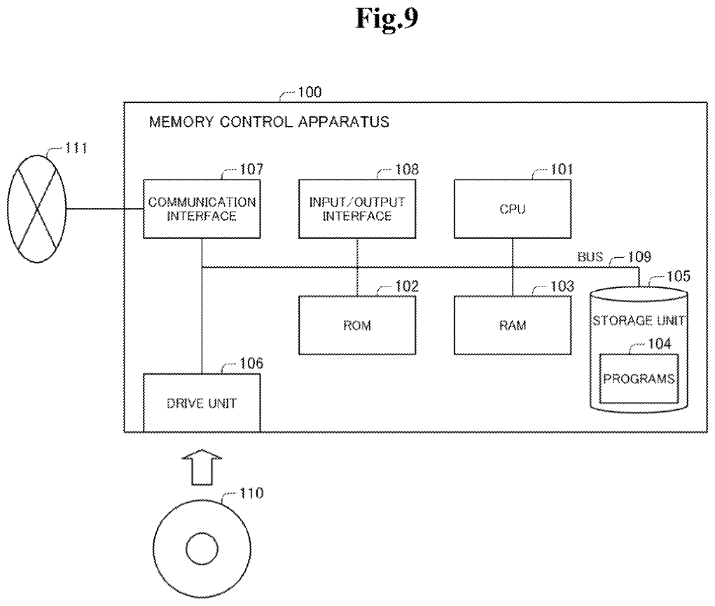

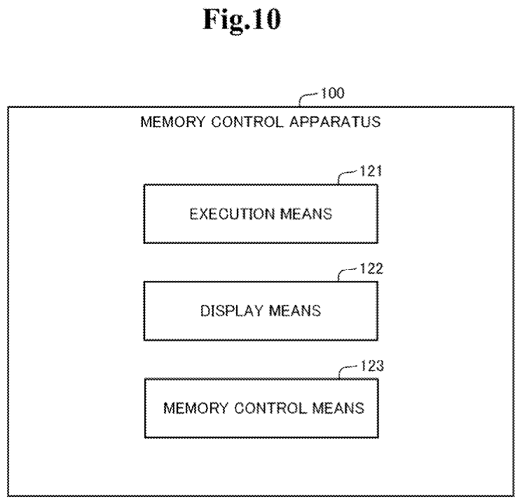

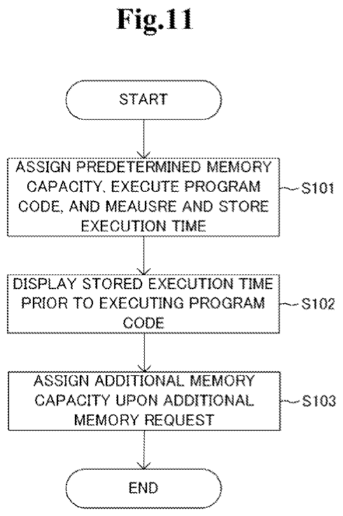

Next, a second example embodiment of the present invention will be described with reference to FIGS. 9 to 11. FIGS. 9 and 10 are block diagrams showing a configuration of a memory control apparatus according to the second example embodiment, and FIG. 11 is a flowchart showing an operation of the memory control apparatus. In the present example embodiment, configurations of the controller and memory control method described in the above example embodiment are outlined.

First, referring to FIG. 9, a hardware configuration of a memory control apparatus 100 according to the present example embodiment will be described. The memory control apparatus 100 consists of a typical information processing apparatus and includes, for example, the following hardware components:
a CPU (central processing unit) 101 (arithmetic logic unit);
a ROM (read-only memory) 102 (storage unit);
a RAM (random-access memory) 103 (storage unit);
programs 104 loaded into the RAM 103;
a storage unit 105 storing the programs 104;
a drive unit 106 that writes and reads to and from a storage medium 110 outside the information processing apparatus;
a communication interface 107 that connects with a communication network 111 outside the information processing apparatus;
an input/output interface 108 through which data is outputted and inputted; and
a bus 109 through which the components are connected to each other.

When the CPU 101 acquires and executes the programs 104, execution means 121, display means 122, and memory control means 123 shown in FIG. 10 are implemented in the memory control apparatus 100. For example, the programs 104 are previously stored in the storage unit 105 or ROM 102, and the CPU 101 loads and executes them into the RAM 103 when necessary. The programs 104 may be provided to the CPU 101 through the communication network 111. Also, the programs 104 may be previously stored in the storage medium 110, and the drive unit 106 may read them therefrom and provide them to the CPU 101. Note that the execution means 121, display means 122, and memory control means 123 may be constituted by a dedicated electronic circuit for implementing such means.

The hardware configuration of the information processing apparatus serving as the memory control apparatus 100 shown in FIG. 9 is illustrative only and is not limiting. For example, the information processing apparatus does not have to include one or some of the above components such as the drive unit 106.

The memory control apparatus 100 performs a memory control method shown in the flowchart of FIG. 11 using the functions of the execution means 121, display means 122, and memory control means 123 implemented based on the programs.

As shown in FIG. 11, the memory control apparatus 100 performs the following steps: executing a program code to which a predetermined memory capacity is assigned and measuring and storing the execution time in which the program code is executed (step S101); displaying execution status information including the execution time prior to newly executing the program code (step S102); and

if an additional memory capacity is requested prior to newly executing the program code, assigning the additional memory capacity to the program code (step S103).

The present invention thus configured displays the execution time measured in the past execution of the program code before the user executes the program code. This allows the user to recognize the past execution status of the program code. If the user requests assignment of an additional memory capacity on the basis of the past execution status, the present invention assigns additional memory to the user. As seen above, the present invention assigns additional memory to the user who wants additional memory on the basis of the past execution status and thus allows the multiple users to efficiently use the shared memory.

The above programs may be stored in various types of non-transitory computer-readable media and provided to a computer. The non-transitory computer-readable media include various types of tangible storage media. The non-transitory computer-readable media include, for example, a magnetic recording medium (for example, a flexible disk, a magnetic tape, a hard disk drive), a magneto-optical recording medium (for example, a magneto-optical disk), a CD-ROM (compact disc read-only memory), a CD-R, a CD-R/W, and a semiconductor memory (for example, a mask ROM, a PROM (programmable ROM), an EPROM (erasable PROM), a flash ROM, a RAM (random-access memory)). The programs may be provided to a computer by using various types of transitory computer-readable media. The transitory computer-readable media include, for example, an electric signal, an optical signal, and an electromagnetic wave. The transitory computer-readable media can provide the programs to a computer via a wired communication channel such as an electric wire or optical fiber, or via a wireless communication channel.

While the present invention has been described with reference to the above-mentioned example embodiments and so on, the present invention is not limited to the example embodiments. The configuration or details of the present invention can be changed in various manners that can be understood by one skilled in the art within the scope of the present invention. At least one or more of the functions of the execution means 121, display means 122, and memory control means 123 may be performed by an information processing apparatus placed at and connected to any place on the network, that is, may be performed by so-called cloud computing.

### <Supplementary Notes>

Some or all of the example embodiments can be described as in Supplementary Notes below. While the configurations of the model creation method, model creation apparatus, and program according to the present invention are outlined below, the present invention is not limited thereto.

### (Supplementary Note 1)

A memory control method comprising:

executing a program code to which a predetermined memory capacity is assigned and measuring an execution time in which the program code is executed;

displaying execution status information including the execution time prior to newly executing the program code; and

when an additional memory capacity is requested prior to newly executing the program code, assigning the additional memory capacity to the program code.

### (Supplementary Note 2)

The memory control method of Supplementary Note 1 further comprising measuring a used memory capacity representing a memory capacity used in execution of the program code, wherein the displaying comprises displaying the used memory capacity along with the execution time as the execution status information prior to newly executing the program code.

### (Supplementary Note 3)

The memory control method of Supplementary Note 1 or 2, wherein the displaying comprises displaying the execution status information along with the program code prior to newly executing the program code.

### (Supplementary Note 4)

The memory control method of any one of Supplementary Notes 1 to 3, wherein the displaying comprises displaying the execution status information measured in the latest execution of the program code prior to newly executing the program code.

### (Supplementary Note 5)

The memory control method of any one of Supplementary Notes 1 to 4, further comprising assigning a predetermined memory capacity to the program code and reserving a surplus memory capacity, wherein the assigning the additional memory capacity comprises when the additional memory capacity is requested prior to newly executing the program code, assigning the surplus memory capacity to the program code as the additional memory capacity.

### (Supplementary Note 6)

The memory control method of Supplementary Note 5,

wherein the assigning and the reserving comprise assigning a predetermined memory capacity to each of the plurality of program codes and reserving a surplus memory capacity, and

wherein the assigning the additional memory capacity comprises when the additional memory capacity is requested prior to newly executing a predetermined program code of the program codes, assigning the surplus memory capacity to the predetermined program code as the additional memory capacity.

### (Supplementary Note 7)

The memory control method of Supplementary Note 6,

wherein the assigning and the reserving comprise guaranteeing and assigning some capacity of a first memory having a predetermined capacity to each of the program codes and reserving a second memory having a predetermined capacity different from the first memory, and

wherein the assigning the additional memory capacity comprises when the additional memory capacity is requested prior to newly executing the predetermined program code, additionally assigning some capacity of the second memory to the predetermined program code.

### (Supplementary Note 8)

The memory control method of Supplementary Note 7, wherein the assigning the additional memory capacity comprises when the additional memory capacity is requested prior to newly executing the predetermined program code, additionally assigning a capacity that has yet to be assigned to the predetermined program code of the first memory to the predetermined program code in accordance with an execution status of the other program code.

### Supplementary Note 8.1

The memory control method of any one of Supplementary Notes 1 to 8, further comprising charging for assignment of the additional memory capacity to the program code upon the request of the additional memory capacity.

### (Supplementary Note 9)

A memory control apparatus comprising:

execution means configured to execute a program code to which a predetermined memory capacity is assigned and to measure an execution time in which the program code is executed;

display means configured to display execution status information including the execution time prior to newly executing the program code; and

memory control means configured to, when an additional memory capacity is requested prior to newly executing the program code, assign the additional memory capacity to the program code.

### (Supplementary Note 10)

The memory control apparatus of Supplementary Note 9,

wherein the execution means measures a used memory capacity representing a memory capacity used in execution of the program code, and

wherein the display means displays the used memory capacity along with the execution time as the execution status information prior to newly executing the program code.

### (Supplementary Note 11)

The memory control apparatus of Supplementary Note 9 or 10, wherein the display means displays the execution status information along with the program code prior to newly executing the program code.

### (Supplementary Note 12)

The memory control apparatus of any one of Supplementary Notes 9 to 11, wherein the display means displays the execution status information measured in the latest execution of the program code prior to newly executing the program code.

### (Supplementary Note 13)

The memory control apparatus of any one of Supplementary Notes 9 to 12,

wherein the memory control means assigns a predetermined memory capacity to the program code and reserves a surplus memory capacity, and

wherein when an additional memory capacity is requested prior to newly executing the program code, the memory control means assigns the surplus memory capacity to the program code as the additional memory capacity.

### (Supplementary Note 14)

The memory control apparatus of Supplementary Note 13,

wherein the memory control means assigns a predetermined memory capacity to each of the plurality of program codes and reserves a surplus memory capacity, and

wherein when the additional memory capacity is requested prior to newly executing a predetermined program code of the program codes, the memory control means assigns the surplus memory capacity to the predetermined program code as the additional memory capacity.

### (Supplementary Note 15)

The memory control apparatus of Supplementary Note 14,

wherein the memory control means guarantees some capacity of a first memory having a predetermined capacity to each of the program codes and reserves a second memory having a predetermined capacity different from the first memory, and

wherein when the additional memory capacity is requested prior to newly executing the predetermined program code, the memory control means additionally assigns some capacity of the second memory to the predetermined program code.

### (Supplementary Note 16)

The memory control apparatus of Supplementary Note 15, wherein when the additional memory capacity is requested prior to newly executing the predetermined program code, the memory control means additionally assigns a capacity that has yet to be assigned to the predetermined program code of the first memory, to the predetermined program code in accordance with an execution status of the other program code.

### (Supplementary Note 16.1)

The memory control apparatus of any one of Supplementary Notes 9 to 16, further comprising charging means configured to charge for assignment of the additional memory capacity to the program code upon the request of the additional memory capacity.

### (Supplementary Note 17)

A program for causing an information processing apparatus to function as:

execution means configured to execute a program code to which a predetermined memory capacity is assigned and to measure an execution time in which the program code is executed;

display means configured to display execution status information including the execution time prior to newly executing the program code; and

memory control means configured to, when an additional memory capacity is requested prior to newly executing the program code, assign the additional memory capacity to the program code.

### REFERENCE SIGNS LIST

1 user terminal
10 controller
11 assignment unit
12 display unit
13 execution unit
14 analysis file storage unit
20 shared server
21 multi-core CPU
22 shared memory
100 memory control apparatus
101 CPU
102 ROM
103 RAM
104 programs
105 storage unit
106 drive unit
107 communication interface
108 input/outside interface
109 bus
110 storage medium
111 communication network
121 execution means
122 display means
123 memory control means

What is claimed is:

1. A memory control method comprising:
executing a program code to which a predetermined memory capacity is assigned and measuring an execution time in which the program code is executed;
displaying execution status information including the execution time prior to newly executing the program code; and
when an additional memory capacity is requested prior to newly executing the program code, assigning the additional memory capacity to the program code.

2. The memory control method of claim 1 further comprising measuring a used memory capacity representing a memory capacity used in execution of the program code, wherein the displaying comprises displaying the used memory capacity along with the execution time as the execution status information prior to newly executing the program code.

3. The memory control method of claim 1, wherein the displaying comprises displaying the execution status information along with the program code prior to newly executing the program code.

4. The memory control method of claim 1, wherein the displaying comprises displaying the execution status information measured in the latest execution of the program code prior to newly executing the program code.

5. The memory control method of claim 1, further comprising assigning a predetermined memory capacity to the program code and reserving a surplus memory capacity, wherein the assigning the additional memory capacity comprises when the additional memory capacity is requested prior to newly executing the program code, assigning the surplus memory capacity to the program code as the additional memory capacity.

6. The memory control method of claim 5,
wherein the assigning and the reserving comprise assigning a predetermined memory capacity to each of the plurality of program codes and reserving a surplus memory capacity, and
wherein the assigning the additional memory capacity comprises when the additional memory capacity is requested prior to newly executing a predetermined program code of the program codes, assigning the surplus memory capacity to the predetermined program code as the additional memory capacity.

7. The memory control method of claim 6,
wherein the assigning and the reserving comprise guaranteeing and assigning some capacity of a first memory having a predetermined capacity to each of the program codes and reserving a second memory having a predetermined capacity different from the first memory, and
wherein the assigning the additional memory capacity comprises when the additional memory capacity is requested prior to newly executing the predetermined program code, additionally assigning some capacity of the second memory to the predetermined program code.

8. The memory control method of claim 7, wherein the assigning the additional memory capacity comprises when the additional memory capacity is requested prior to newly executing the predetermined program code, additionally assigning a capacity that has yet to be assigned to the predetermined program code of the first memory to the predetermined program code in accordance with an execution status of the other program code.

9. The memory control method of claim 1, further comprising charging for assignment of the additional memory capacity to the program code upon the request of the additional memory capacity.

10. A memory control apparatus comprising:
at least one memory configured to store instructions; and
at least one processor configured to execute instructions to:
execute a program code to which a predetermined memory capacity is assigned and measure an execution time in which the program code is executed;
display execution status information including the execution time prior to newly executing the program code; and
when an additional memory capacity is requested prior to newly executing the program code, assign the additional memory capacity to the program code.

11. The memory control apparatus of claim 10,
wherein the at least one processor is configured to execute the instructions to measure a used memory capacity representing a memory capacity used in execution of the program code, and
wherein the at least one processor is configured to execute the instructions to display the used memory capacity along with the execution time as the execution status information prior to newly executing the program code.

12. The memory control apparatus of claim 10, wherein the at least one processor is configured to execute the instructions to display the execution status information along with the program code prior to newly executing the program code.

13. The memory control apparatus of claim 10, wherein the at least one processor is configured to execute the instructions to display the execution status information measured in the latest execution of the program code prior to newly executing the program code.

14. The memory control apparatus of claim 10,
wherein the at least one processor is configured to execute the instructions to assign a predetermined memory capacity to the program code and reserve a surplus memory capacity, and
wherein when the additional memory capacity is requested prior to newly executing the program code, the at least one processor is configured to execute the instructions to assign the surplus memory capacity to the program code as the additional memory capacity.

15. The memory control apparatus of claim 14,
wherein the at least one processor is configured to execute the instructions to assign a predetermined memory capacity to each of the plurality of program codes and reserves a surplus memory capacity, and
wherein when the additional memory capacity is requested prior to newly executing a predetermined program code of the program codes, the at least one processor is configured to execute the instructions to assign the surplus memory capacity to the predetermined program code as the additional memory capacity.

16. The memory control apparatus of claim 15,
wherein the at least one processor is configured to execute the instructions to guarantee some capacity of a first memory having a predetermined capacity to each of the program codes and reserve a second memory having a predetermined capacity different from the first memory, and
wherein when the additional memory capacity is requested prior to newly executing the predetermined program code, the at least one processor is configured to execute the instructions to additionally assign some capacity of the second memory to the predetermined program code.

17. The memory control apparatus of claim 16, wherein when the additional memory capacity is requested prior to newly executing the predetermined program code, the at least one processor is configured to execute the instructions to additionally assign a capacity that has yet to be assigned to the predetermined program code of the first memory, to the predetermined program code in accordance with an execution status of the other program code.

18. The memory control apparatus of claim 10, wherein the at least one processor is configured to execute the instructions to charge for assignment of the additional memory capacity to the program code upon the request of the additional memory capacity.

19. A non-transitory computer-readable storage medium storing a program for causing an information processing apparatus to execute instructions to:
execute a program code to which a predetermined memory capacity is assigned and to measure an execution time in which the program code is executed;
display execution status information including the execution time prior to newly executing the program code; and
when an additional memory capacity is requested prior to newly executing the program code, assign the additional memory capacity to the program code.
